(19) United States
(12) Patent Application Publication
(10) Pub. No.: US 2013/0052627 A1
(43) Pub. Date: Feb. 28, 2013

(54) TIME ZONE TUTORIAL DEVICE

(71) Applicant: Shui-Tan TZENG, Taichung (TW)

(72) Inventor: Shui-Tan TZENG, Taichung (TW)

(21) Appl. No.: 13/222,137

(22) Filed: Aug. 31, 2011

(51) Int. Cl. G09B 19/12

(52) U.S. Cl. 434/304

(57) ABSTRACT

A time zone tutorial device includes: a panel on which a time circle is disposed, the time circle being divided into 24 equal parts, the 24 equal parts being sequentially counterclockwise marked with numerals to represent time; a time zone turntable disposed on a front face of the panel, the time zone turntable having the form of a disc, the time zone turntable having an Equator circle marked with 24 time zones; an indicator positioned on a rear face of the time zone turntable and synchronously rotatable with the time zone turntable, the indicator having an indication section; and a connection member for sequentially connecting the time zone turntable, the indicator and the panel, whereby the time zone turntable is rotatable relative to the panel.

### FIELD OF THE INVENTION

The present invention relates generally to a tutorial implement, and more particularly to a time zone tutorial device.

### BACKGROUND OF THE INVENTION

There are 24 hours in one day. This is because the time for the earth to rotate by one circle is divided into 24 hours. The time when the earth right faces the sun is set midday 12 o'clock (noon) as the basis for time. The earth is divided into 24 time zones according to the different relative positions between respective areas of the earth and the sun during rotation of the earth. Conventionally, the earth is divided into 24 time zones within 360°. Each time zone is 15°. Basically, Greenwich (London, England) Meridian Line, longitude 0°, is the center of world time. The forward 7.5° and backward 7.5° from the center are set the same time zone. From longitude 0° to the west, every other 15° western longitude is sequentially set the center of the time zone, including W15°,W30°,W45°,W60°,W75°,W90°,W105°,W120°,W135°,W150°,W165° and 180° (International Date Line). From longitude 0° to the east, there are sequentially east longitudes of E15°,E30°,E45°,E60°,E75°,E90°,E105°,E120°,E135°,E150° and E165° to meet 180°. Accordingly, there are totally 24 time zones. Different places in the world pertain to different time zones due to different relative positions to the sun. Therefore, the times of different time zones are different at the same time.

Everybody has learnt the conception of time and time zone from natural science lessons in schools. However, most of the peoples only have a smattering of the conception of time and time zone and are confused about time conversion.

### SUMMARY OF THE INVENTION

It is therefore a primary object of the present invention to provide a time zone tutorial device, which practically enables a user to instinctively realize time and have a clear conception of time zones.

The present invention can be best understood through the following description and accompanying drawings, wherein:

### BRIEF DESCRIPTION OF THE DRAWINGS

FIG. 1 is a plane assembled view of a first embodiment of the present invention;

FIG. 2 is a plane view of the panel of the first embodiment of the present invention according to FIG. 1, showing the structure of the panel;

FIG. 3 is a plane view of the time zone turntable of the first embodiment of the present invention according to FIG. 1, showing the structure of the time zone turntable;

FIG. 4 is a perspective view of the indicator of the first embodiment of the present invention;

FIG. 5 is a top view of the indicator of the first embodiment of the present invention;

FIG. 6 is a side view of the indicator of the first embodiment of the present invention;

FIG. 7 is a side assembled view of the first embodiment of the present invention;

FIG. 8 is a plane assembled view of the first embodiment of the present invention, showing the use thereof;

FIG. 9 is a plane assembled view of a second embodiment of the present invention; and

FIG. 10 is a side assembled view of the second embodiment of the present invention.

### DETAILED DESCRIPTION OF THE PREFERRED EMBODIMENTS

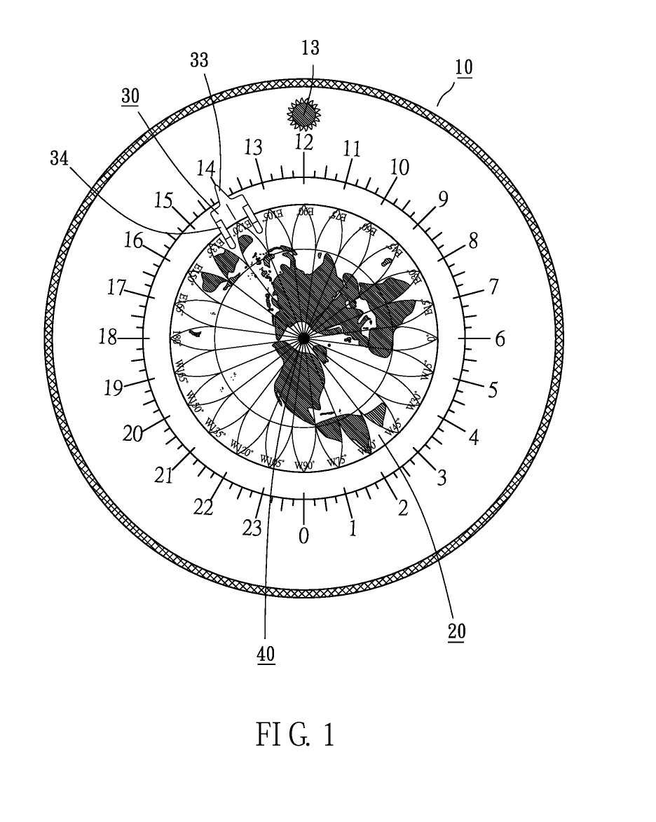

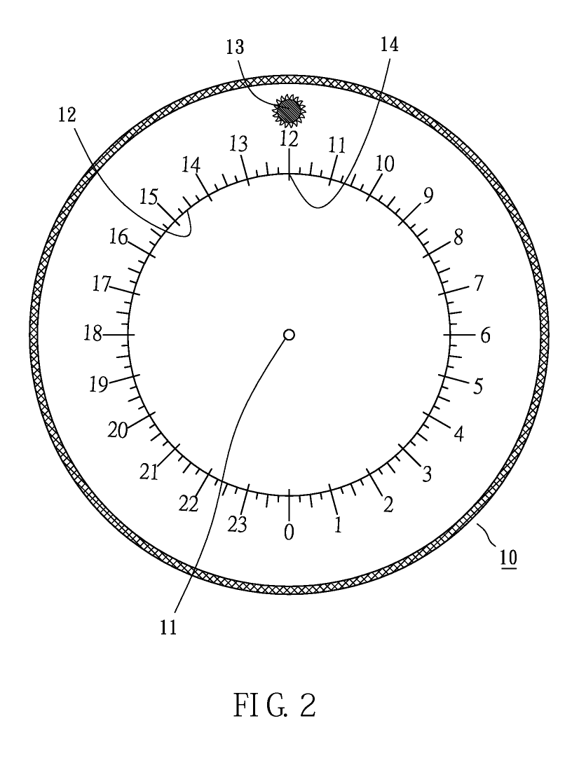

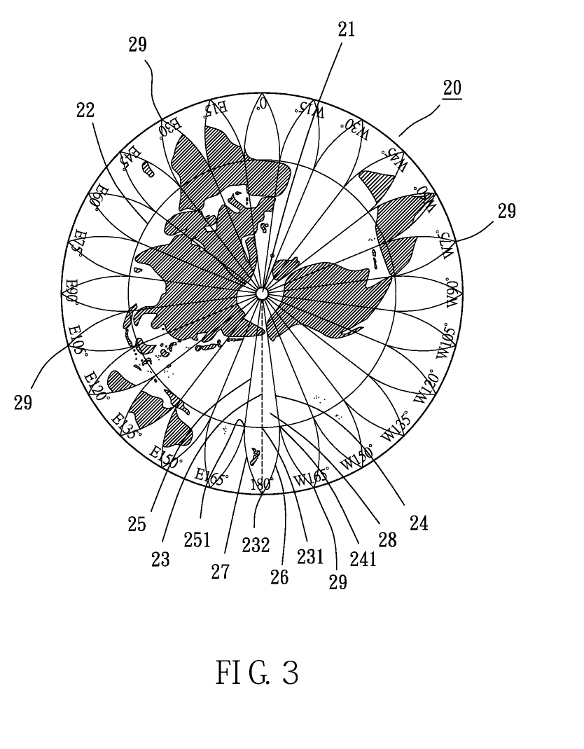

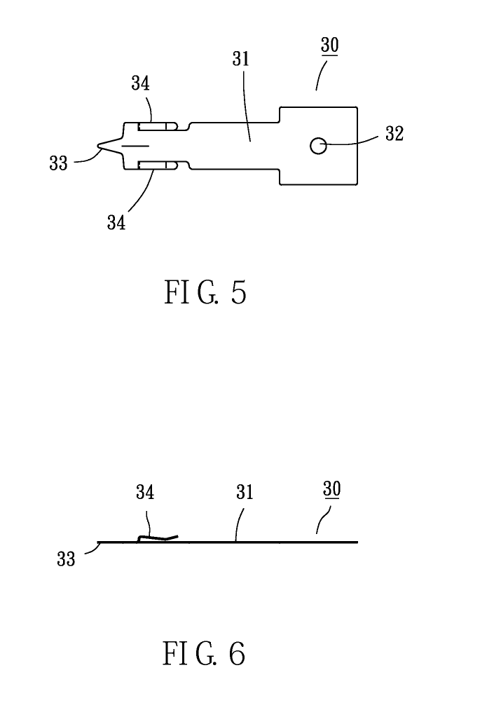

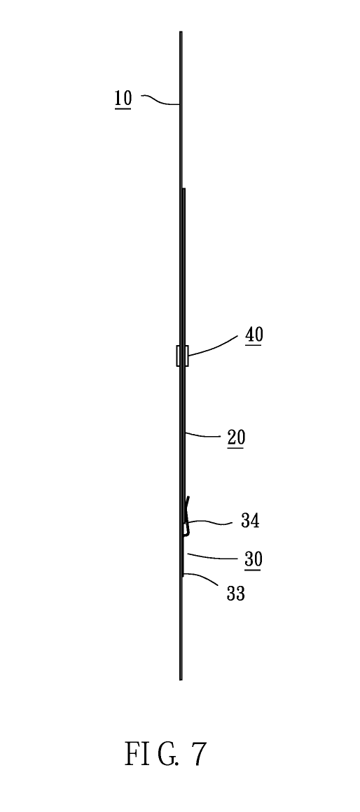

Please refer to FIGS. 1 to 7. According to a first embodiment, the present invention includes a panel 10. A first perforation section 11 is formed at a center of the panel 10. A time circle 12 with a predetermined radius is formed on the panel 10 and centered at a center of the first perforation section 11. A sun FIG. 13 is positioned on right upper side of the panel 10 to indicate the position of the sun. The connection line between the center of the first perforation section 11 and a center of the sun FIG. 13 intersects the time circle 12 at a first intersection point 14. The first intersection point 14 is marked with a numeral of 12 to mean midday 12 o'clock. The time circle 12 is divided into 24 equal parts. From the midday 12 o'clock position, the 24 equal parts are sequentially counterclockwise marked with numerals of 13, 14, 15, 16, 17, 18, 19, 20, 21, 22, 23, 0, 1, 2, 3, 4, 5, 6, 7, 8, 9, 10, 11 to mean the other 23 hours.

The present invention further includes a time zone turntable 20 disposed on a front face of the panel 10. The time zone turntable 20 has the form of a disc. The time zone turntable 20 has a radius smaller than that of the time circle 12 of the panel 10. A second perforation section 21 is formed at a center of the time zone turntable 20 to mean the position of the North Pole. An Equator circle 22 with a predetermined radius is formed on the time zone turntable 20 and centered at a center of the second perforation section 21. A first straight line 23 extends from the center of the second perforation section 21 to the right lower side of the time zone turntable 20 to mean the International Date Line. The first straight line 23 intersects the Equator circle 22 at a second intersection point 231 and intersects the outer circumference of the time zone turntable 20 at a third intersection point 232. A second straight line 24 extends from the center of the second perforation section 21 on the right side of the first straight line 23. The second straight line 24 is spaced from the first straight line 23 by 7.5 degrees. The second straight line 24 intersects the Equator circle 22 at a fourth intersection point 241. A third straight line 25 extends from the center of the second perforation section 21 on the left side of the first straight line 23. The third straight line 25 is spaced from the first straight line 23 by 7.5 degrees. The third straight line 25 intersects the Equator circle 22 at a fifth intersection point 251. A first arcuate line 26 is connected between the fourth intersection point 241 and the third intersection point 232. A second arcuate line 27 is connected between the fifth intersection point 251 and the third intersection point 232. The second straight line 24, the third straight line 25, the first arcuate line 26 and the second arcuate line 27 together define a first time zone 28. On the basis of the first time zone 28, the other 23 time zones are defined in a counterclockwise sequence at 15-degree intervals. The outer ends of the 23 time zones lie in the outer circumference of the time zone turntable 20 as sixth intersection points 29. The third intersection point 232 is marked with 180° to mean the meridian at 180° longitude. From the third intersection point 232, the sixth intersection points 29 are counterclockwise sequentially marked with west longitudes of W165°,W150°,W135°,W120°,W105°,W90°,W75°,W60°,W45°,W30°,W15° and 0° Greenwich Meridian. From the third intersection point 232, the other sixth intersection points 29 are clockwise sequentially marked with east longitudes of E165°,E150°,E135°,E120°,E105°,E90°,E75°,E60°,E45°,E30° and E15° to meet the 0°. Accordingly, a world time zone map including 24 time zones is completed. Finally, with reference to a commercially available world map, the five continents including Asia, Europe, Africa, Latin America, North America and Australia and some main islands of the world are substantially drafted on the time zone turntable 20 at the longitudes and latitudes corresponding to their actual longitudes and latitudes to form the time zone map.

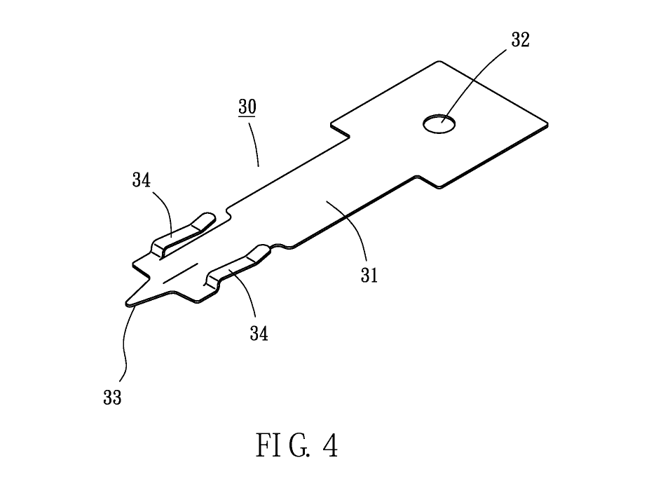

The present invention further includes an indicator 30 positioned on rear face of the time zone turntable 20 between the panel 10 and the time zone turntable 20 as shown in FIGS. 4 to 6. The indicator 30 has an elongated board section 31. A third perforation section 32 is formed on a right section of the elongated board section 31. A left end of the elongated board section 31 is formed with an indication section 33. In addition, elastic clipping sections 34 are disposed on a left section of the elongated board section 31. A part of the outer circumference of the time zone turntable 20 is clipped between the elongated board section 31 and the elastic clipping sections 34 by certain tightness.

The present invention further includes a connection member 40. The connection member 40 sequentially passes through the second perforation section 21 of the time zone turntable 20, the third perforation section 32 of the indicator 30 and the first perforation section 11 of the panel 10 to connect the time zone turntable 20, the indicator 30 and the panel 10 with each other. Accordingly, the time zone turntable 20 is rotatable relative to the panel 10.

In use, a user first upward bias the elastic clipping sections 33 of the indicator 30 to rotate the time zone turntable 20 to set the indicator 30 in his/her own time zone. Then the elastic clipping sections 33 are released to restore to the clipping state.

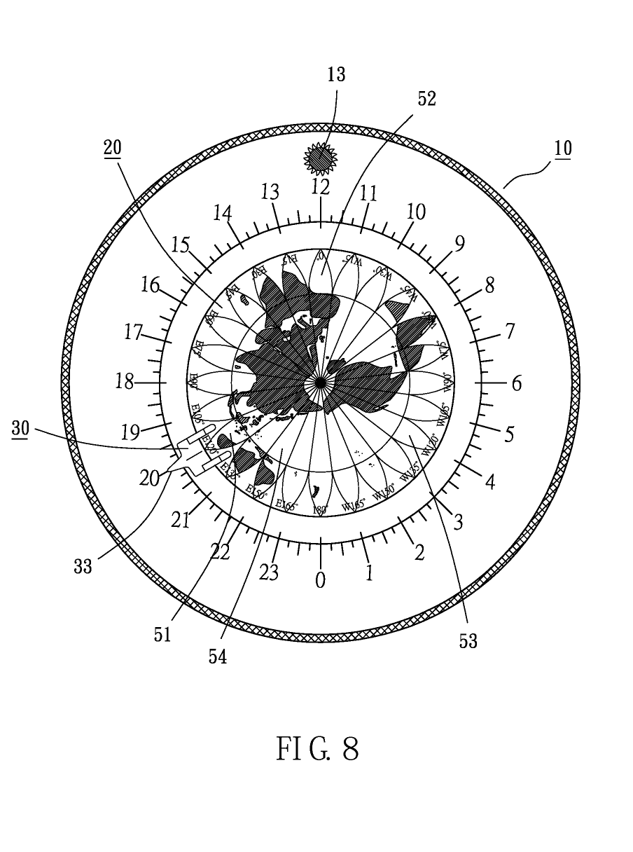

As shown in FIG. 8, in case the user is in Taiwan, the user can set the indicator in the E120° time zone 51 to which Taiwan pertains. In the case that it is now 20:00 in Taiwan, the user only needs to rotate the time zone turntable 20 to direct the indication section 33 of the indicator 30 to the position of the numeral 20 on the panel 10. At this time, if the user wants to know what time it is in London, England, the user can find the time zone 52 of England at 0° longitude on the time zone turntable 20. The outer end of the time zone 52 points at a time of midday 12:00, which is right the current time in London, England. Similarly, the user can find the time zone 53 of Los Angeles on west side of America at W120° longitude on the time zone turntable 20. The outer end of the time zone 53 points at a time of 4:00, which is right the current time in Los Angeles. Also, it can be seen on the time zone turntable 20 that Sydney on east side of Australia lies in time zone 54 at E150° longitude. The outer end of the time zone 54 points at a time of 22:00, which is right the current time in Sydney.

In other words, when a user desires to know the current time in whatever country or city in the world, the user only needs to know the east longitude or west longitude where the country or the city is. Then the user can find the time zone of the country or the city on the time zone turntable 20. The time pointed by the outer end of the time zone is right the current time of that district. Accordingly, the current time of everywhere in the world can be known from the time zone map of the time zone turntable 20.

Therefore, no matter whether the user is flying in the sky or sailing on a sea or traveling on a land, the user only needs to know the longitude where he/she is to directly know the time from the time zone map without time conversion. This is very convenient.

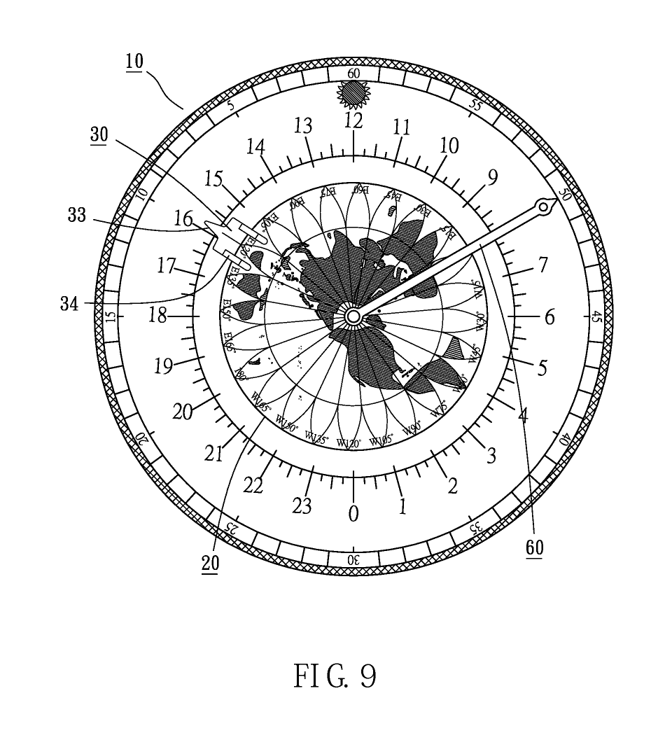

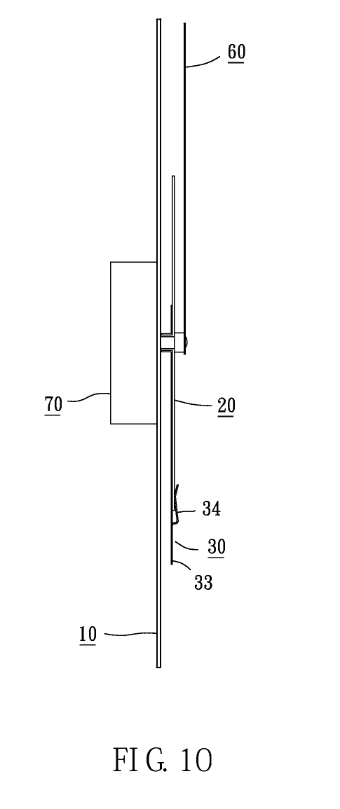

Please further refer to FIGS. 9 and 10, which show a second embodiment of the present invention. According to the second embodiment, the time zone tutorial device of the present invention includes a panel 10, a time zone turntable 20, an indicator 30, a minute indicator 60 and a drive assembly 70.

The panel 10, the time zone turntable 20 and the indicator 30 of the second embodiment are identical to those of the first embodiment in structure. The connection member 40 is replaced with the drive assembly 70.

The minute indicator 60 is disposed on a front face of the time zone turntable 20.

The drive assembly 70 is disposed on a rear face of the panel 10. The drive assembly 70 includes multiple gears inside. A rotary shaft is disposed on a front side of the drive assembly 70 to connect and drive the time zone turntable 20, the indicator 30 and the minute indicator 60 to continuously clockwise rotate. The indicator 30 is synchronously rotatable with the time zone turntable 20 to indicate hours.

The sun FIG. 13 on the upper side of the panel 10 represents the sun still at the center of the solar system. The sun serves as the basis for time. When the earth rotates with some time zone right facing the sun, it is midday 12:00 in that time zone. The time zone turntable 20 continuously rotates in conformity with the actual rotational direction (from west side to east side) of the earth. When the time zone turntable 20 rotates by one circle along with the indicator 30 for 24 hours, this means the earth rotates by one circle for one day, that is, 24 hours. Accordingly, a user can easily realize how time is created and why there are different time zones. Therefore, the user can have a clear conception of rotation of the earth to further have a view of the whole world.

Moreover, the five continents including Asia, Europe, Africa, Latin America, North America and Australia and the islands of the world can be drafted on the time zone turntable 20 with different colors to facilitate distinction between the lands and oceans. Accordingly, the relative positions of the time zones where the five continents are can be more clearly shown.

According to the above, the present invention has the following tutorial functions:
1. The move of the time zone turntable 20 implies the rotation of the earth. The rotational direction of the time zone turntable 20, the indicator 30 and the minute indicator 60 complies with the rotational direction from west side to east side of the earth. The change of relative positions between the time zone turntable 20 and the sun FIG. 13 represents the change of time. A user can see the rotation of the time zone turntable 20 to have the conception of change of time. That is, when the earth rotates, the relative positions between the earth and the sun change to create time, while the sun keeps still. Each circle of rotation of the earth takes one day, that is, 24 hours. Accordingly, the earth is divided into 24 time zones.
2. The sun FIG. 13 is disposed on the upper side of the panel 10 to indicate the position of the sun. When the time zone where we are right faces the sun, it is midday 12:00 in the time zone as the basis for the time. The relative positions between different areas of the world and the sun vary so that the current times of different time zones are different.
3. The time zone turntable 20 is designed with time zone map centered at the North Pole, which is divided into 24 time zones. During the rotation of the time zone turntable 20, the local times of everywhere of the world are indicated without conversion of time. Therefore, it is very convenient to use the time zone tutorial device of the present invention.

The above embodiments are only used to illustrate the present invention, not intended to limit the scope thereof. Many modifications of the above embodiments can be made without departing from the spirit of the present invention.

1. A time zone tutorial device comprising:
a panel having a first perforation section, a time circle with a predetermined radius being formed on the panel and centered at a center of the first perforation section, a sun Figure being positioned on right upper side of the panel, a connection line between the center of the first perforation section and a center of the sun Figure intersecting the time circle at a first intersection point, the first intersection point being marked with a numeral of 12, the time circle being divided into 24 equal parts, from the midday 12 o'clock position, the 24 equal parts being sequentially counterclockwise marked with numerals of 13, 14, 15, 16, 17, 18, 19, 20, 21, 22, 22, 23, 0, 1, 2, 3, 4, 5, 6, 7, 8, 9, 10, 11;
a time zone turntable disposed on a front face of the panel, the time zone turntable having the form of a disc, the time zone turntable having a radius smaller than that of the time circle of the panel, the time zone turntable having a second perforation section to mean the position of the North Pole, an Equator circle with a predetermined radius being formed on the time zone turntable and centered at a center of the second perforation section, a first straight line extending from the center of the second perforation section to the right lower side of the time zone turntable to mean the International Date Line, the first straight line intersecting the Equator circle at a second intersection point and intersecting an outer circumference of the time zone turntable at a third intersection point, a second straight line extending from the center of the second perforation section on the right side of the first straight line, the second straight line being spaced from the first straight line by 7.5 degrees, the second straight line intersecting the Equator circle at a fourth intersection point, a third straight line extending from the center of the second perforation section on the left side of the first straight line, the third straight line being spaced from the first straight line by 7.5 degrees, the third straight line intersecting the Equator circle at a fifth intersection point, a first arcuate line being connected between the fourth intersection point and the third intersection point, a second arcuate line being connected between the fifth intersection point and the third intersection point, the second straight line, the third straight line, the first arcuate line and the second arcuate line together defining a first time zone, on the basis of the first time zone, the other 23 time zones being defined in a counterclockwise sequence at 15-degree intervals, outer ends of the 23 time zones lying in the outer circumference of the time zone turntable as sixth intersection points, the third intersection point being marked with 180° to mean the meridian at 180° longitude, from the third intersection point, the sixth intersection points being counterclockwise sequentially marked with west longitudes of W165°,W150°,W135°,W120°,W105°,W90°,W75°,W60°,W45°,W30°,W15° and 0°, from the third intersection point, the other sixth intersection points being clockwise sequentially marked with east longitudes of E165°, E150°, E135°,E120°, E105°, E90°, E75°, E60°, E45°, E30° and E15° to meet the 0°, whereby a world time zone map including 24 time zones is completed;
an indicator positioned on rear face of the time zone turntable and synchronously rotatable with the time zone turntable; and
a connection member, the connection member sequentially passing through the second perforation section of the time zone turntable, a third perforation section of the indicator and the first perforation section of the panel to connect the time zone turntable, the indicator and the panel with each other, whereby the time zone turntable is rotatable relative to the panel.

2. The time zone tutorial device as claimed in claim 1, wherein the indicator has an elongated board section, the third perforation section being formed on a right section of the elongated board section, a left end of the elongated board section being formed with an indication section, elastic clipping sections being disposed on a left section of the elongated board section, a part of the outer circumference of the time zone turntable being clipped between the elongated board section and the elastic clipping sections by certain tightness.

3. The time zone tutorial device as claimed in claim 1, wherein a time zone map is disposed on the time zone turntable, the time zone map being composed of the five continents including Asia, Europe, Africa, Latin America, North America and Australia and some main islands of the world, which are substantially drafted on the time zone turntable at the longitudes and latitudes corresponding to their actual longitudes and latitudes to form the time zone map.

4. The time zone tutorial device as claimed in claim 3, wherein the five continents including Asia, Europe, Africa, Latin America, North America and Australia and the islands of the world drafted on the time zone turntable are drafted with different colors.

5. A time zone tutorial device comprising:
a panel having a first perforation section, a time circle with a predetermined radius being formed on the panel and centered at a center of the first perforation section, a sun Figure being positioned on right upper side of the panel, a connection line between the center of the first perforation section and a center of the sun Figure intersecting the time circle at a first intersection point, the first intersection point being marked with a numeral of 12, the time circle being divided into 24 equal parts, from the midday 12 o'clock position, the 24 equal parts being sequentially counterclockwise marked with numerals of 13, 14, 15, 16, 17, 18, 19, 20, 21, 22, 22, 23, 0, 1, 2, 3, 4, 5, 6, 7, 8, 9, 10, 11;
a time zone turntable disposed on a front face of the panel, the time zone turntable having the form of a disc, the time zone turntable having a radius smaller than that of the time circle of the panel, the time zone turntable having a second perforation section to mean the position of the North Pole, an Equator circle with a predetermined radius being formed on the time zone turntable and centered at a center of the second perforation section, a first straight line extending from the center of the second perforation section to the right lower side of the time zone turntable to mean the International Date Line, the first straight line intersecting the Equator circle at a second intersection point and intersecting an outer circumference of the time zone turntable at a third intersection point, a second straight line extending from the center of the second perforation section on the right side of the first straight line, the second straight line being spaced from the first straight line by 7.5 degrees, the second straight line intersecting the Equator circle at a fourth intersection point, a third straight line extending from the center of the second perforation section on the left side of the first straight line, the third straight line being spaced from the first straight line by 7.5 degrees, the third straight line intersecting the Equator circle at a fifth intersection point, a first arcuate line being connected between the fourth intersection point and the third intersection point, a second arcuate line being connected between the fifth intersection point and the third intersection point, the second straight line, the third straight line, the first arcuate line and the second arcuate line together defining a first time zone, on the basis of the first time zone, the other 23 time zones being defined in a counterclockwise sequence at 15-degree intervals, outer ends of the 23 time zones lying in the outer circumference of the time zone turntable as sixth intersection points, the third intersection point being marked with 180° to mean the meridian at 180° longitude, from the third intersection point, the sixth intersection points being counterclockwise sequentially marked with west longitudes of W165°,W150°,W135°,W120°,W105°,W90°,W75°,W60°,W45°,W30°,W15° and 0°, from the third intersection point, the other sixth intersection points being clockwise sequentially marked with east longitudes of E165°, E150°, E135°, E120°, E105°, E90°, E75°, E60°, E45°, E30° and E15° to meet the 0°, whereby a world time zone map including 24 time zones is completed;
an indicator positioned on rear face of the time zone turntable and synchronously rotatable with the time zone turntable;
a minute indicator disposed on a front face of the time zone turntable; and
a drive assembly in substitution for the connection member, the drive assembly being disposed on a rear face of the panel, the drive assembly including multiple gears inside, a rotary shaft being disposed on a front side of the drive assembly to connect and drive the time zone turntable, the indicator and the minute indicator to continuously clockwise rotate, the indicator being synchronously rotatable with the time zone turntable to indicate hours.

6. The time zone tutorial device as claimed in claim 5, wherein the indicator has an elongated board section, the third perforation section being formed on a right section of the elongated board section, a left end of the elongated board section being formed with an indication section, elastic clipping sections being disposed on a left section of the elongated board section, a part of the outer circumference of the time zone turntable being clipped between the elongated board section and the elastic clipping sections by certain tightness.

7. The time zone tutorial device as claimed in claim 5, wherein a time zone map is disposed on the time zone turntable, the time zone map being composed of the five continents including Asia, Europe, Africa, Latin America, North America and Australia and some main islands of the world, which are substantially drafted on the time zone turntable at the longitudes and latitudes corresponding to their actual longitudes and latitudes to form the time zone map.

8. The time zone tutorial device as claimed in claim 7, wherein the five continents including Asia, Europe, Africa, Latin America, North America and Australia and the islands of the world drafted on the time zone turntable are drafted with different colors.

9. The time zone tutorial device as claimed in claim 2, wherein a time zone map is disposed on the time zone turntable, the time zone map being composed of the five continents including Asia, Europe, Africa, Latin America, North America and Australia and some main islands of the world, which are substantially drafted on the time zone turntable at the longitudes and latitudes corresponding to their actual longitudes and latitudes to form the time zone map.

10. The time zone tutorial device as claimed in claim 6, wherein a time zone map is disposed on the time zone turntable, the time zone map being composed of the five continents including Asia, Europe, Africa, Latin America, North America and Australia and some main islands of the world, which are substantially drafted on the time zone turntable at the longitudes and latitudes corresponding to their actual longitudes and latitudes to form the time zone map.
